(19) United States
(12) Patent Application Publication
(10) Pub. No.: US 2007/0279022 A1
(43) Pub. Date: Dec. 6, 2007

(54) Power converter and magnetic structure thereof

(75) Inventors: Wei Chen, Taoyuan Hsien (TW); Zeng-Yi Lu, Taoyuan Hsien (TW)

Correspondence Address: BIRCH STEWART KOLASCH & BIRCH, PO BOX 747, FALLS CHURCH, VA, 22040-0747, US

(73) Assignee: DELTA ELECTRONICS INC.

(21) Appl. No.: 11/797,862

(22) Filed: May 8, 2007

(30) Foreign Application Priority Data
Jun. 2, 2006 (TW) 095119609

(51) Int. Cl. G05F 1/00

(52) U.S. Cl. 323/272

(57) ABSTRACT

A power converter includes a power generating unit, a first transformer, a first switching unit, a second switching unit, a first inductor and a power outputting unit. The power generating unit generates a power signal. The first and second switching units are electrically connected to the power generating unit and respectively generate a first switching signal and a second switching signal according to the power signal. The first transformer is electrically connected to the first switching unit and the second switching unit and has a first winding and a second winding. The first and second switching signals are respectively inputted to first ends of the first and second windings. The first inductor is electrically connected to the second end of the first winding and a second end of the second winding. The power outputting unit is electrically connected to the first inductor and the second end of the second winding.

This Non-provisional application claims priority under 35 U.S.C. §119(a) on Patent Application No(s). 095119609 filed in Taiwan, Republic of China on Jun. 2, 2006, the entire contents of which are hereby incorporated by reference.

### BACKGROUND OF THE INVENTION

1. Field of Invention

The invention relates to a power converter and a magnetic structure thereof, and, in particular, to a buck power converter and a magnetic structure thereof.

2. Related Art

As shown in FIG. 1, a conventional multi-channel DC to DC converter 1 has channels composed of a set of switching elements 11 and an inductor 12, converts the DC power DC inputted to the switching elements 11 into the desired DC power DC according to on and off operations of the switching elements 11 and the energy storage principle of the inductor 12, and then outputs the desired DC power DC from an output terminal OUT. This converter is only composed of the switching elements and the inductor, so it is difficult to achieve an improved design, such as a current ripple, for controlling circuit parameters.

As shown in FIG. 2, another conventional multi-channel DC to DC power converter 2 utilizes a transformer 13 with a shared core coupled to each channel. In this case, each channel is still composed of a set of switching elements 11 and an inductor 12. The inductor 12 serves as a filter inductor for keeping the waveform of the DC power DC outputted from the output terminal OUT in a more stable state. This converter needs an inductor in each channel to serve as a filter, which increases the number of magnetic elements in the circuit, and complicates the analysis and design of the circuit.

As shown in FIG. 3, still another conventional multi-channel DC to DC power converter 3 utilizes a switching element 11 and an inverse coupling transformer 14 to couple to each channel, and the DC power DC coupled to each channel is transferred to an output inductor 15 and an output capacitor 16 and outputted from an output terminal OUT in order to reduce the ripples generated in the channel. The output inductor of this converter has to withstand the sum of the current values of all the channels. Thus, the load on the output inductor 15 is increased, the loss is increased and the heat energy processing cannot be easily controlled.

As mentioned hereinabove, the DC to DC power converters that are presently used often have the above-mentioned problems. Thus, it is an important subject of the invention to provide a power converter capable of mitigating channel current ripple, reducing the inductance loss and integrating the magnetic elements in the circuit, and a magnetic structure used in the power converter.

### SUMMARY OF THE INVENTION

In view of the foregoing, the invention is to provide a power converter capable of reducing channel current ripples and improving the winding loss, and a magnetic structure thereof.

To achieve the above, the invention discloses a power converter including a power generating unit, a first switching unit, a second switching unit, a first transformer, a first inductor and a power outputting unit. The power generating unit generates a power signal. The first switching unit is electrically connected to the power generating unit and generates a first switching signal according to the power signal. The second switching unit is electrically connected to the power generating unit and generates a second switching signal according to the power signal. The first transformer is electrically connected to the first and second switching units. The first transformer has a first winding and a second winding each having a first end and a second end. The first and second switching signals are inputted to the first end of the first and second winding, respectively. The first inductor is electrically connected to the second ends of the first and second windings. The power outputting unit is electrically connected to the first inductor and the second end of the second winding.

In addition, the invention discloses a magnetic structure of a power converter including a first magnetic body, a first coil and a second coil. The first coil is wound around the first magnetic body. The second coil is wound around the first magnetic body substantially in parallel with the first coil. A portion of the second coil is disposed opposite to the first coil.

As mentioned above, the power converter and the magnetic structure thereof according to the invention reallocate the connection property between the winding and the inductor of each transformer, and a number or the entirety of the channels of each winding of the transformer is electrically connected to the inductor. Thus, the current ripple of the channel formed in each winding of the transformer and the heat allocation of the power converter can be well controlled, and the inductor electrically connected to each channel can also be obtained according to the leakage inductance of the transformer. In addition, the channel current ripple can be mitigated and the inductance loss can be reduced by designing the required transformer and inductor in the same magnetic body according to the magnetic structure formed by the corresponding magnetic bodies.

### BRIEF DESCRIPTION OF THE DRAWINGS

The invention will become more fully understood from the detailed description given herein below illustration only, and thus is not limitative of the present invention, and wherein:

FIGS. 1 to 3 are schematic illustrations showing conventional multi-channel DC to DC power converters;

FIG. 4 is a schematic illustration showing a power converter according to a first embodiment of the invention;

FIG. 5 is a schematic illustration showing a portion of a filter of FIG. 4;

FIG. 6 is a schematic illustration showing a power converter according to a second embodiment of the invention;

FIGS. 7 and 8 are schematic illustrations showing another power converter according to the second embodiment of the invention;

FIG. 9 is a schematic illustration showing a partial and practical structure of FIG. 4;

FIG. 10 is a schematic illustration showing a magnetic structure of a power converter according to an embodiment of the invention;

FIGS. 11 and 12 are schematic illustrations showing cross-sectional areas of the first magnetic body and the second magnetic body of FIG. 9;

FIGS. 13 to 15 are other schematic illustrations showing other magnetic structures of the power converter according to the embodiment of the invention; and

FIG. 16 is a schematic illustration showing a design, in which the magnetic structure according to the embodiment of the invention is applied to a multi-channel power converter.

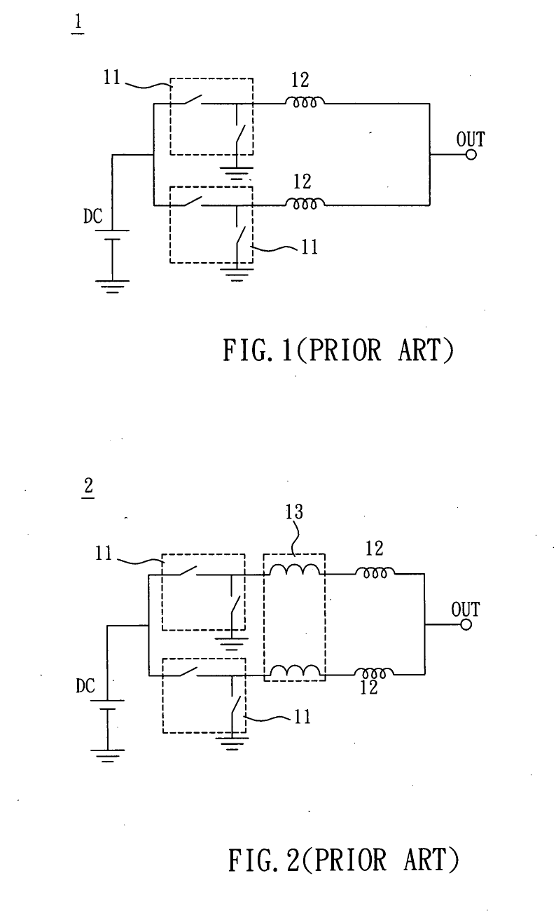

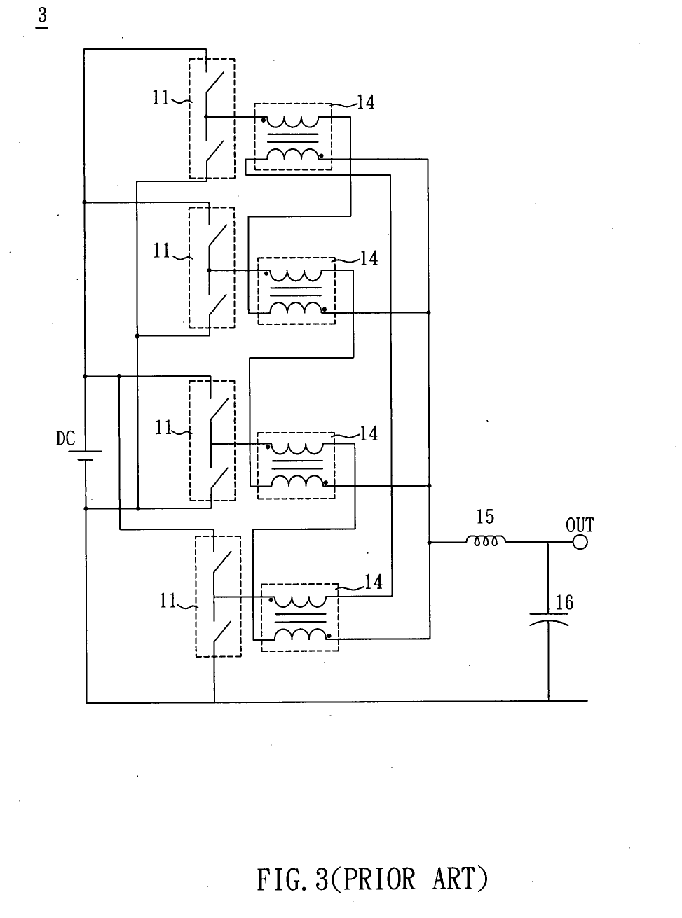

### DETAILED DESCRIPTION OF THE INVENTION

The present invention will be apparent from the following detailed description, which proceeds with reference to the accompanying drawings, wherein the same references relate to the same elements.

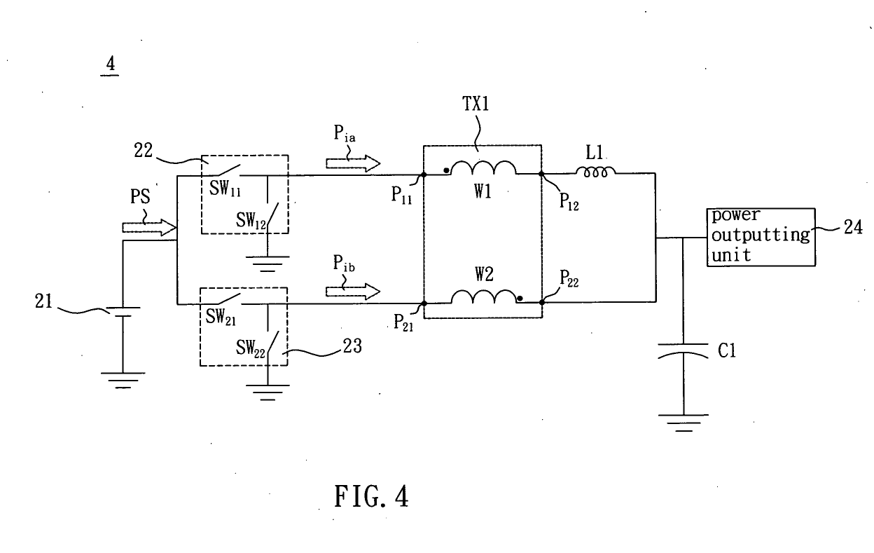

Referring to FIG. 4, a power converter 4 according to a first embodiment of the invention includes a power generating unit 21, a first transformer TX1, a first switching unit 22, a second switching unit 23, a first inductor L1 and a power outputting unit 24. In this embodiment, the power converter is a DC to DC buck power converter (or buck converter), which is a dual-channel power converter in the example to be described.

The power generating unit 21 generates a power signal PS. In this embodiment, the power signal PS is a DC power signal.

The first switching unit 22 is electrically connected to the power generating unit 21, and generates a first switching signal Pᵢₐ according to the power signal PS. The second switching unit 23 is electrically connected to the power generating unit 21 and generates a second switching signal P_{ib} according to the power signal PS. In this embodiment, a phase difference of 180 degrees exists between the first switching signal Pᵢₐ and the second switching signal P_{ib}, and is determined according to the operations of the first and second switching units 22, 23.

The first transformer TX1 is electrically connected to the first switching unit 22 and the second switching unit 23, and has a first winding W1 and a second winding W2. The first winding W1 has a first end P₁₁ and a second end P₁₂, and the second winding W2 has a first end P₂₁ and a second end P₂₂. The first switching signal Pᵢₐ is inputted to the first end P₁₁ of the first winding W1, and the second switching signal P_{ib} is inputted to the first end P₂₁ of the second winding W2. In this embodiment, the first transformer TX1 is a phase-inversion transformer.

As mentioned hereinabove, the first and second switching units 22, 23 in this embodiment respectively have first switching elements SW₁₁ and SW₂₁ and second switching elements SW₁₂ and SW₂₂. The first and second switching elements SW₁₁, SW₁₂ of the first switching unit 22 are electrically connected to the first winding W1 of the first transformer TX1 in parallel, and the first and second switching elements SW₂₁, SW₂₂ of the second switching unit 23 are electrically connected to the second winding W2 of the first transformer TX1 in parallel. The first switching elements SW₁₁ and SW₂₁ and the second switching elements SW₁₂ and SW₂₂ can be bipolar transistors (BJT) or field effect transistors (FET), respectively.

As shown in FIG. 4, the first inductor L1 is electrically connected to the second end P₁₂ of the first winding W1 and the second end P₂₂ of the second winding W2. The power outputting unit 24 is electrically connected to the first inductor L1 and the second end P₂₂ of the second winding W2 in order to output the converted power signal.

In this embodiment, the power converter 4 further includes a capacitor C1, which is electrically connected to the power outputting unit 24, and the capacitor C1 and the first inductor L1 form a low pass filter.

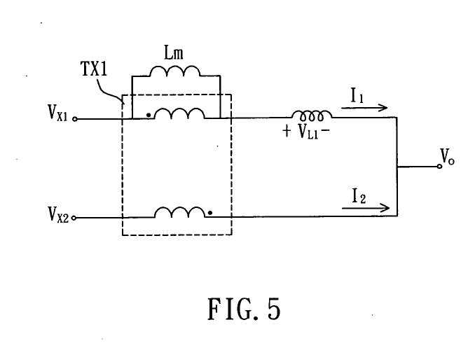

In order to facilitate the circuit analysis, please refer to FIG. 5, which is a schematic illustration showing a portion of the filter of FIG. 4, i.e., a schematic illustration showing a portion of the circuit after the power signal passes through the switching unit. Herein, Lm represents a magnetizing inductance of the first transformer TX1, V_{L1} represents a crossover voltage between two ends of the first inductor L1 in FIG. 4; V_{X1} represents a voltage of a first power signal-after passing through the first switching unit 22, V_{X2} represents a voltage of a second power signal after passing through the second switching unit 23, and V_{O} represents a voltage of the power outputting unit 24 in FIG. 4. A current slew rate of a current I₁ flowing through the first winding W1 (channel 1) and a current slew rate of a current I₂ flowing through the second winding W2 (channel 2) after a crossover voltage V_{L1} between the two ends of the first inductor L1 is applied are respectively represented by the following equations:

$$\begin{matrix}{V}_{L 1} = ( {V}_{X 1} + {V}_{X 2} ) - 2 {V}_{O} & ( 1 ) \\ \frac{d {I}_{1}}{d t} = \frac{( {V}_{X 1} + {V}_{X 2} ) - 2 {V}_{O}}{L 1} & ( 2 ) \\ \frac{d {I}_{2}}{d t} = \frac{{V}_{X 1} + {V}_{X 2} - 2 {V}_{O}}{L 1} - \frac{{V}_{X 2} - {V}_{O}}{Lm} & ( 3 )\end{matrix}$$

As shown in Equations (2) and (3), a current ripple of the channel 1 is determined according to the input voltages of the first inductor L1 and the channel 1, and the input voltage and the output voltage of the channel 2. The current ripple of the channel 2 is determined according to the first inductor L1 of the channel 1, the magnetizing inductance Lm of the first transformer TX1 and the input voltage of the channel 1 through the coupling relation of the first transformer TX1.

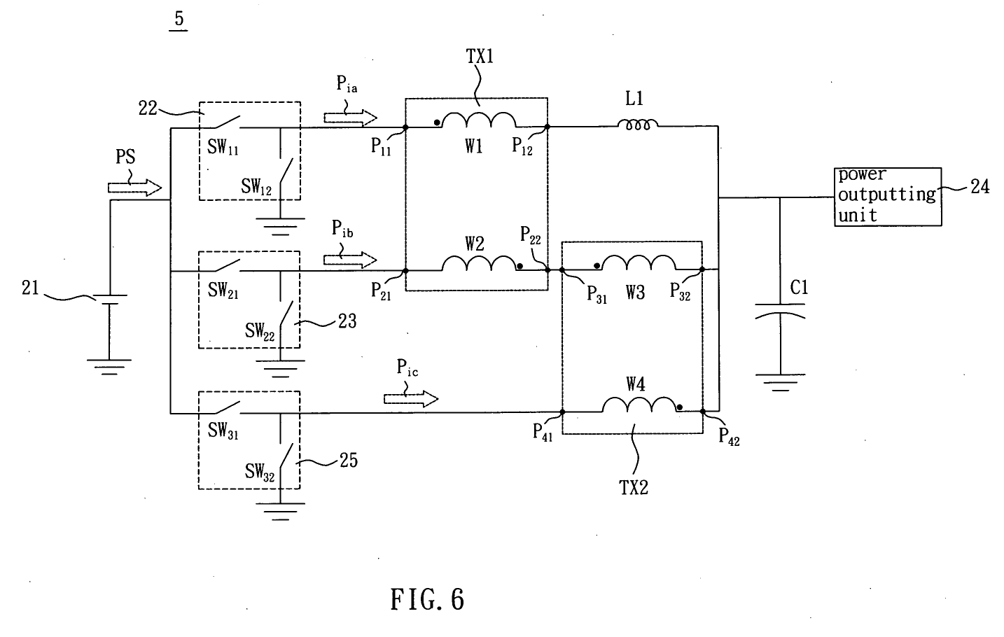

As shown in FIG. 6, a power converter 5 according to the second embodiment of the invention to be illustrated is a three-channel power converter. The power converter 5 includes the power generating unit 21, the first transformer TX1, the first switching unit 22, the second switching unit 23, the first inductor L1, the capacitor C1 and the power outputting unit 24, which are the same as those of the first embodiment shown in FIG. 4, and further includes a second transformer TX2 and a third switching unit 25. The second transformer TX2 is the same as the first transformer and is a phase-inversion transformer, and the third switching unit 25 is also the same as the first and second switching units 22, 23 and thus has first and second switching elements SW₃₁, SW₃₂. The first and second switching elements SW₃₁, SW₃₂ can be respectively bipolar transistors (BJT) or field effect transistors (FET).

The third switching unit 25 is electrically connected to the power generating unit 21 and generates a third switching signal P_{ic} according to the power signal PS. In this embodiment, the phase differences between the first switching signal Pᵢₐ, the second switching signal P_{ib} and the third switching signal P_{ic} are 120 degrees, and are determined according to on and off operations of the first, second and third switching units 22, 23, 25.

The second transformer TX2 is electrically connected to the third switching unit 25 and the first transformer TX1. The second transformer TX2 has third and fourth windings W3, W4. The third winding W3 has first and second ends P₃₁, P₃₂, and the fourth winding W4 also has first and second ends P₄₁, P₄₂. In addition, the third switching signal P_{ic} generated by the third switching unit 25 is inputted to the first end P₄₁ of the fourth winding W4. In this embodiment, the first end P₃₁ of the third winding W3 is electrically connected to the second end P₂₂ of the second winding W2 of the first transformer TX1, the first inductor L1 is electrically connected to the second end P₃₂ of the third winding W3, and the first inductor L1 is electrically connected to the second winding W2 through the third winding W3. In addition, the power outputting unit 24 is electrically connected to the first inductor L1 as well as the second end P₃₂ of the third winding W3 and the second end P₄₂ of the fourth winding W4, and the power outputting unit 24 is electrically connected to the second end P₂₂ of the second winding W2 through the third winding W3.

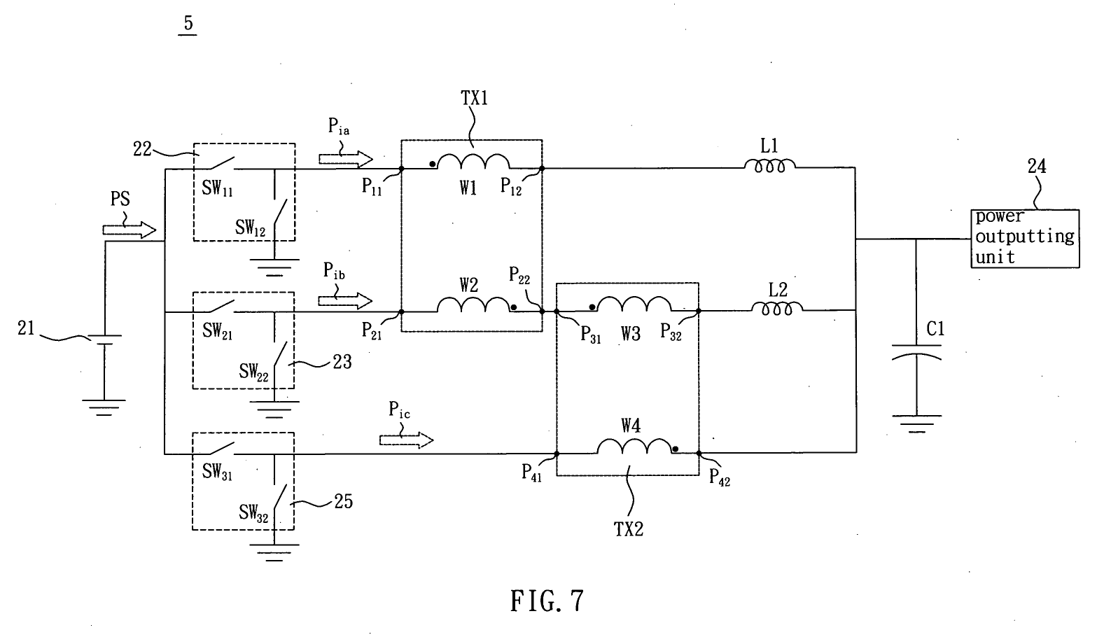

Referring to FIG. 7, the power converter 5 further includes a second inductor L2 electrically connected to the first inductor L1 and the second end P₃₂ of the third winding W3. The first inductor L1 is electrically connected to the second end P₂₂ of the second winding W2 through the second inductor L2 and the third winding W3. Herein, the power outputting unit 24 is further electrically connected to the second inductor L2 and the second end P₄₂ of the fourth winding W4 of the second transformer TX2, and the power outputting unit 24 is electrically connected to the second inductor L2 of the second winding W2 through the second inductor L2 and the third winding W3.

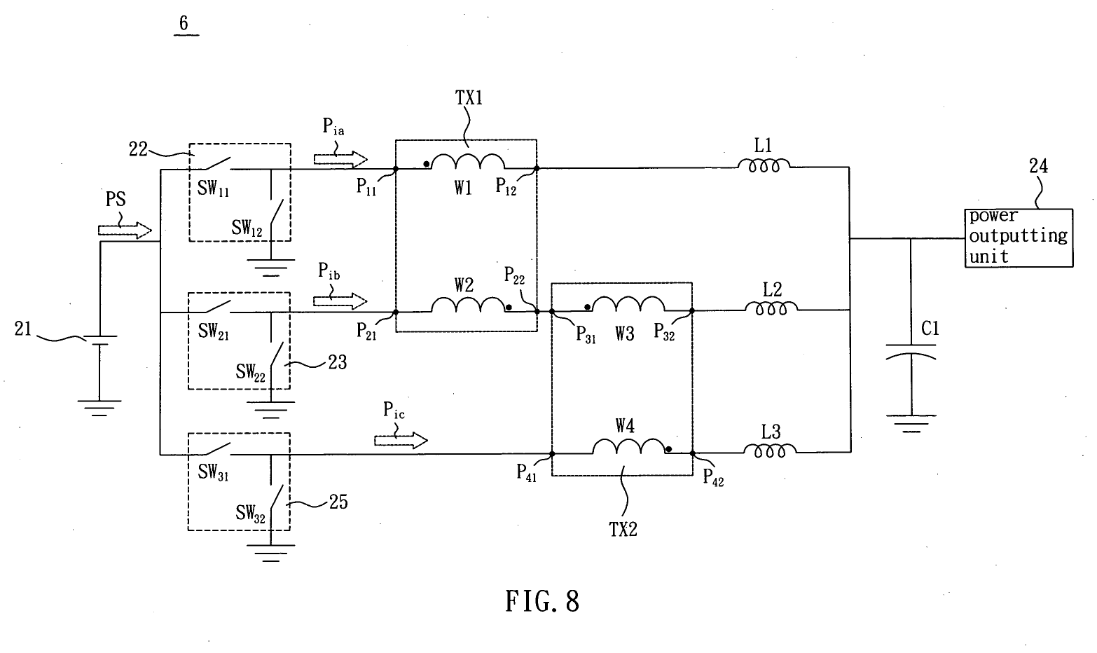

Referring to FIG. 8, the power converter 6 in this embodiment further includes a third inductor L3 in addition to the elements of the power converter 5. The third inductor L3 is electrically connected to the second end P₄₂ of the fourth winding W4 of the second transformer TX2 and the second inductor L2.

It is to be noted that the above-mentioned inductors are described by taking independent electronic elements (e.g., L1, L2 and L3) as an example. Of course, in the point of view of the equivalent circuit, the inductor can also be implemented using a leakage inductance of the transformer. In addition, the first and second embodiments of this invention are described by taking dual-channel and three-channel power converters as examples. Of course, the embodiment can also be expanded to the multi-channel power converter, and detailed descriptions thereof will be omitted.

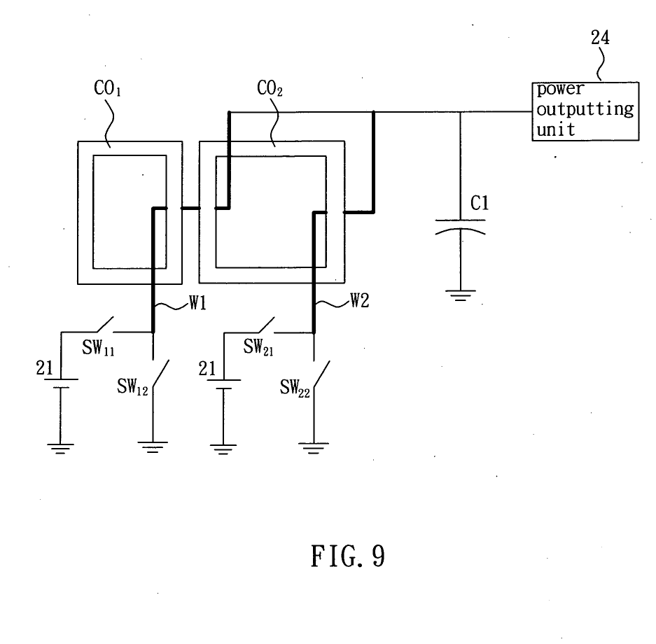

Taking the dual-channel power converter 4 of the first embodiment as an example, the practical structure of the power converter is shown in FIG. 9, in which the first winding W1 is wound around one side of a first annular core CO₁ and one side of a second annular core CO₂, and the second winding W2 is wound around another side of the second annular core CO₂. Consequently, the first annular core CO₁ and the first winding W1 wound around the first annular core CO₁ can correspond to the first inductor L1 of the power converter 4, and the second annular core CO₂ and the first winding W1 and the second winding W2 wound around the second annular core CO₂ may correspond to the first transformer TX1 of the power converter 4. However, other modifications of the above-mentioned embodiment may also be connected according to this rule to form the power converter 5, 6 or other power converters.

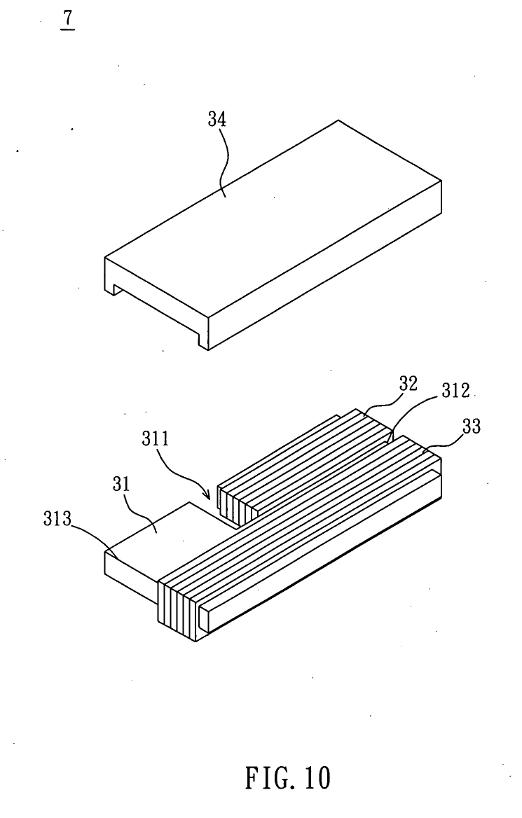

The magnetic structure of the power converter of the invention will be described hereinbelow. Referring to FIG. 10, a magnetic structure 7 of the power converter according to the embodiment of the invention includes a first magnetic body 31, a first coil 32 and a second coil 33. In this embodiment, the first magnetic body 31 has a first groove 311.

The first coil 32 is wound around the first magnetic body 31. In this embodiment, the first coil 32 is wound between the first groove 311 and a lateral side 312 of the first magnetic body 31.

The second coil 33 is wound around the first magnetic body 31 and substantially in parallel with the first coil 32, and at least a portion of the second coil 33 faces the first coil 32. In this embodiment, the second coil 33 is wound between the lateral side 312 and another lateral side 313 opposite to the lateral side 312.

Herein, the portion of the first coil 32 and the at least portion of the second coil 33 opposite each other correspond to the first transformer TX1 shown in FIG. 4, and the other portion of the second coil 33 and the other portion of the first coil 32, which are not opposite each other, correspond to the first inductor L1 shown in FIG. 4. In other words, the first transformer TX1 of the power converter 4 of the embodiment and the first inductor L1 may be implemented by one magnetic structure 7.

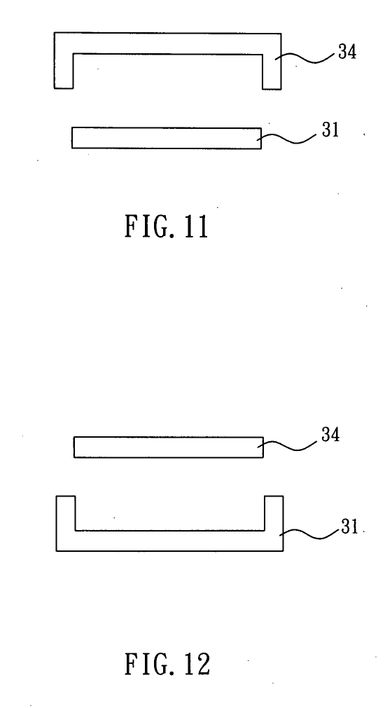

In addition, the magnetic structure 7 further includes a second magnetic body 34, which covers at least one portion of the first magnetic body 31, the first coil 32 and the second coil 33. The first magnetic body 31 has an I-shaped cross-sectional area roughly perpendicular to the first coil 32, and the second magnetic body 34 has a U-shaped cross-sectional area roughly perpendicular to the first coil 32, as shown in FIG. 11. Of course, the first magnetic body 31 has a U-shaped cross-sectional area roughly perpendicular to the first coil 32, and the second magnetic body 34 has an I-shaped cross-sectional area roughly perpendicular to the first coil 32, as shown in FIG. 12 so that the first magnetic body 31 and the second magnetic body 34 may be combined together.

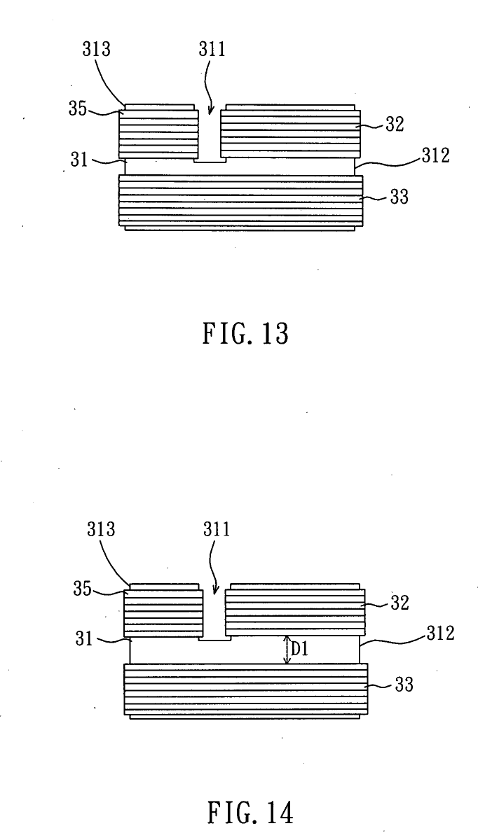

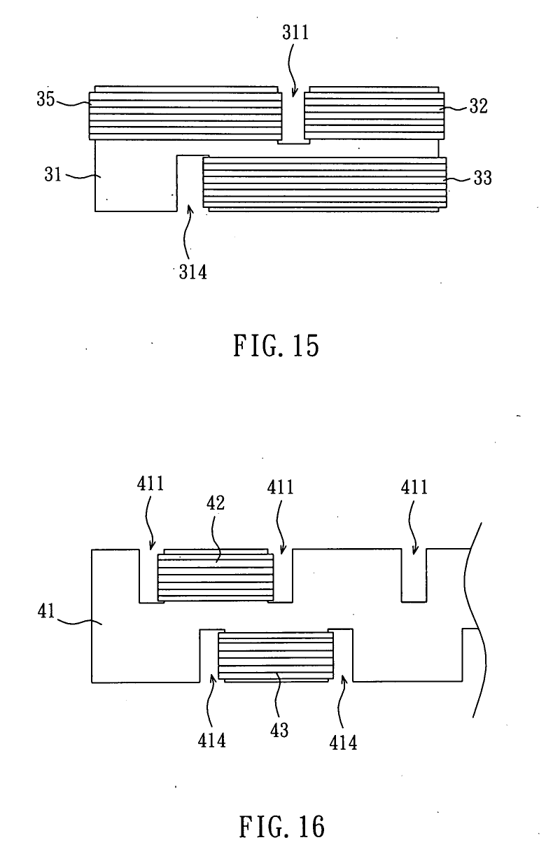

Referring again to FIG. 13, the first magnetic body 31 of this embodiment further includes a third coil 35 which is roughly parallel to the second coil 33 and wound between the first groove 311 and the lateral side 313. Consequently, the magnetic structure 7 may also be simply designed as a transformer. In addition, as shown in FIG. 14, a distance D1 can be designed between the first coil 32 and the second coil 33 of the magnetic structure 7 in the first inductor L1 of the power converter 4 of this embodiment so that the effect of the first inductor L1 can be achieved according to the principle of the leakage inductance of the transformer. In other words, the length of the lateral side 312 or 313 of the first magnetic body 31 is greater than a sum of the widths of the first coil 32 and the second coil 33. Furthermore, the second coil 33 can be wound between the lateral sides 312 and 313 of the first magnetic body 31, and a second groove 314 may also be formed in the first magnetic body 31, as shown in FIG. 15. The second groove 314 and the first groove 311 are opposite each other and are disposed alternately, and the second coil 33 can be wound between the second groove 314 and the lateral side 312 or the lateral side 313 so that the design of the magnetic structure 7 is more flexible.

When the magnetic structure is designed according to the multi-channel power converter, as shown in FIG. 16, the first magnetic body 41 has multiple first grooves 411 and multiple second grooves 414, wherein the first grooves 411 and the second grooves 414 are opposite each other and are disposed alternately. The first coil 42 is wound between the two adjacent first grooves 411, and the second coil 43 is wound between the two adjacent second grooves 414. Of course, more channels may need more coils, and the other coils may also be disposed between other two adjacent first grooves 411 or two adjacent second grooves 414 according to the arrangement mode of the first coil 42 and the second coil 43.

In summary, the power converter and the magnetic structure thereof according to the invention re-allocate the connection property between the winding and the inductor of each transformer, and a number of the channels of each winding in the transformer are electrically connected to the inductor. Thus, the current ripple of the channel formed in each winding of the transformer and the heat allocation of the power converter can be well controlled. In addition, the channel current ripple may be mitigated and the inductance loss may be reduced by designing the required transformer and inductor in the same magnetic body according to the magnetic structure formed by the corresponding magnetic bodies.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A power converter comprising:
a power generating unit for generating a power signal;
a first switching unit electrically connected to the power generating unit to generate a first switching signal according to the power signal;
a second switching unit electrically connected to the power generating unit to generate a second switching signal according to the power signal;
a first transformer electrically connected to the first switching unit and the second switching unit and having a first winding and a second winding, each of which has a first end and a second end, wherein the first switching signal is inputted to the first end of the first winding, and the second switching signal is inputted to the first end of the second winding;
a first inductor electrically connected to the second ends of the first winding and the second winding; and
a power outputting unit electrically connected to the first inductor and the second end of the second winding.

2. The power converter according to claim 1, wherein a phase difference between the first switching signal and the second switching signal is 180 degrees.

3. The power converter according to claim 1, further comprising a capacitor electrically connected to the power outputting unit, wherein the capacitor and the first inductor form a low pass filter.

4. The power converter according to claim 1, further comprising:
a third switching unit electrically connected to the power generating unit to generate a third switching signal according to the power signal; and
a second transformer electrically connected to the third switching unit and the first transformer and having a third winding and a fourth winding, each of which has a first end and a second end,
wherein the first end of the third winding is electrically connected to the second end of the second winding of the first transformer, the first end of the fourth winding is electrically connected to the third switching unit, and the third switching signal is inputted to the fourth winding.

5. The power converter according to claim 4, wherein the power outputting unit is electrically connected to the second end of the third winding and the second end of the fourth winding.

6. The power converter according to claim 4, wherein the first inductor is electrically connected to the second end of the third winding.

7. The power converter according to claim 4, further comprising a second inductor electrically connected to the first inductor and the second end of the third winding.

8. The power converter according to claim 7, wherein the power outputting unit is further electrically connected to the second inductor and the second end of the fourth winding of the second transformer.

9. The power converter according to claim 4, wherein phase differences between the first switching signal, the second switching signal and the third switching signal are 120 degrees.

10. The power converter according to claim 4, further comprising a third inductor electrically connected to the first inductor and the second end of the fourth winding.

11. The power converter according to claim 4, wherein:
the first switching unit has a first switching element and a second switching element, both of which are electrically connected to the first winding in parallel;
the second switching unit has a first switching element and a second switching element, both of which are electrically connected to the second winding in parallel; and
the third switching unit has a first switching element and a second switching element, both of which are electrically connected to the fourth winding in parallel.

12. The power converter according to claim 4, wherein the first switching unit, the second switching unit or the third switching unit is a bipolar transistor (BJT) or a field effect transistor (FET).

13. A magnetic structure of a power converter, comprising:
a first magnetic body;
a first coil wound around the first magnetic body; and
a second coil wound around the first magnetic body substantially in parallel with the first coil, wherein a portion of the second coil is disposed opposite to the first coil.

14. The magnetic structure according to claim 13, wherein the first magnetic body has a first groove, and the first coil is wound between one side of the first magnetic body and the first groove.

15. The magnetic structure according to claim 14, wherein the second coil is wound between the one side of the first magnetic body and around another side of the first magnetic body opposite to the one side of the first magnetic body.

16. The magnetic structure according to claim 14, further comprising a third coil, which is substantially parallel to the second coil and wound between the first groove and another side opposite to the one side.

17. The magnetic structure according to claim 14, wherein the first magnetic body further has a second groove, the second groove and the first groove are opposite to each other and are disposed alternately, and the second coil is wound between the second groove and the one side.

18. The magnetic structure according to claim 13, wherein the first magnetic body has a plurality of first grooves and a plurality of second grooves opposite to the first grooves, and the first grooves and the second grooves are disposed alternately.

19. The magnetic structure according to claim 18, wherein the first coil is wound between the two adjacent first grooves, the second coil is wound between the two adjacent second grooves, and the first coil and the second coil are disposed alternately.

20. The magnetic structure according to claim 13, wherein the first magnetic body has a U-shaped or I-shaped cross-sectional area substantially perpendicular to the first coil.

21. The magnetic structure according to claim 13, further comprising a second magnetic body for covering at least one portion of the first magnetic body, the first coil and the second coil.

22. The magnetic structure according to claim 13, wherein a distance between the first coil and the second coil exists.

23. The magnetic structure according to claim 13, further comprising a first annular core, wherein first annular core and the first coil wound around the first coil form a first inductor.

24. The magnetic structure according to claim 13, further comprising a second annular core, wherein the second annular core and the first coil and the second coil wound around the second annular core form a first transformer.

25. The magnetic structure according to claim 13, wherein a length of one side of the first magnetic body is greater than a sum of widths of the first coil and the second coil.
